(19) United States
(12) Patent Application Publication
(10) Pub. No.: US 2022/0258643 A1
(43) Pub. Date: Aug. 18, 2022

(54) Power supply to charging stations for electric vehicles

(71) Applicant: EVC PowerTech Ltd, Cambridge (GB)

(72) Inventor: Michael Peter Boxwell, Birmingham (GB)

(21) Appl. No.: 17/671,623

(22) Filed: Feb. 15, 2022

(30) Foreign Application Priority Data
Feb. 15, 2021 (GB) 2102122.5

(51) Int. Cl. B60L 53/67; B60L 53/66; H02J 7/00

(52) U.S. Cl. CPC B60L 53/67; H02J 7/00032; H02J 7/0013; B60L 53/66

(57) ABSTRACT

A charging system for charging a plurality of electric vehicles simultaneously comprising: a plurality of charging points; a first plurality of power modules, each one of the first plurality of power modules being connected to a respective one of the plurality of charging points; a second plurality of power modules, each one of the second plurality of power modules being switchably connectable to any one of the plurality of charging points, and a controller configured to control the switchable connections between the second plurality of power modules and the plurality of charging points.

### FIELD OF THE INVENTION

The invention relates to a power supply system for electric vehicle charging stations. In particular, it relates to the system for allocating the available power to a plurality of electric vehicle charging stations.

### BACKGROUND OF THE INVENTION

The batteries of most electric vehicles, including hybrid vehicles (collectively hereafter: EVs) can be charged using a DC power supply provided at an external EV charging point. Many EV batteries can receive a very large charging current for rapid charging, if sufficient power is available. Rapid charging of this kind can typically be completed in twenty to forty minutes, and this period is reducing as technology improves.

Typical EV charging points comprise a plurality of power modules which convert electricity received from, for example, the national grid, and convert it to direct current of the appropriate voltage to be supplied to a connected EV battery. It is common for more than one power module to be connected to a single EV battery, especially for rapid charging operations.

Most EV charging points are limited to charging only one EV at a time. Some solutions exist in the prior art to charge multiple EVs simultaneously using a single charging system, but these have a number of limitations, examples of which will now be presented.

CN102800902 (Lixin and Hanglong) discloses a system providing multiple charging points, each with respective dedicated power modules. Although this system is capable of charging more than one EV at a time, the power supply to each charging point is fixed, meaning that the capacity of all unused charging points is wasted.

US2015123613 (Koolen et al.) discloses a system providing multiple charging points and a plurality of power modules, wherein the power modules can be switchably allocated between the charging points. This allows more than one power module to be connected to a single charging point, providing a power boost and enabling rapid charging. Nevertheless, once all power modules are allocated during a charging operation, no power is available to the remaining charging points meaning that EVs can be connected to the system without receiving any charge.

US2018001781 (Quattrini and Vaughan) provides a plurality of charging points which can cooperate to charge a single vehicle. This has the same problem as Koolen et al. in that once all of the charging capacity has been allocated, other vehicles cannot be charged. There are also dangers associated with running high voltage and high current power cables between charging points.

A similar limitation exists in EP2751902 (Tesla), which discloses a multi-vehicle charging system having a plurality of a charging points and a plurality of power modules, wherein each power module is switchably connectable to any one of the charging points. Once all power modules are allocated, no power is available to the remaining charging points, except by reducing the power supply to a vehicle already being supplied by an in-use port.

CN209111974U discloses an EV charging system with a plurality of charging points, each supplied by means of a power cable. Each of the power cables is switchably connected to all of the other power cables. When a particular charging point is not in use, its power cable can be connected to the power cable of another charging point which is in use, thereby boosting the in-use charging point. Although this allows for the allocation of additional power to heavily loaded charging points, it only does so by disabling other charging points, reducing the number of vehicles that can be charged simultaneously.

US2018123360 presents a centralised power supply and control system for a plurality of charging points, comprising a single main power module connected to all of the charging points, and a plurality of smaller, switchable power modules connected to respective individual charging points. When a power boost is required at one of the charging points, the smaller power module connected to that charging point is activated. The flexibility of this system is limited, and when the smaller power modules are not in use with their respective charging points, their capacity is wasted.

The central EV charge system of the present invention seeks to overcome some of the disadvantages of the prior art by providing a network of charging points, supplied by a central power supply system which provides flexible power boosting to particular charging points as required, without removing the power supply to any of the others, while significantly reducing wasted capacity.

### SUMMARY OF THE INVENTION

The central EV charge system is designed to charge multiple EVs simultaneously by means of a plurality of charging points. Rather than each charging point having its own power modules, each charging point is supplied by a central system of interconnected power modules, allocated and controlled by a central control system.

The central EV charge system comprises two groups of power modules. The first group consists of power modules permanently connected to respective individual charging points, so that each charging point has at least one power module connected at all times.

The second group of power modules consists of a pool of power modules, each of which can be connected to any one of the charging points. This means that a charging point requiring a power boost can be connected to additional power modules from unallocated modules in the second group, if they are available, without reducing the power supplied to the other charging points.

This provides for a very flexible EV charging system which mitigates the disadvantages of the prior art identified above, and which can easily be installed in existing EV charging stations, since it comprises a single, central system.

Since all of the charging points connected to the system share power modules from the pool of power modules in the second group, a degree of flexibility can be achieved that would otherwise require far more power modules and considerably greater expense.

Because power is allocated a single, central control system, the demand across the whole network of charging points is prevented from exceeding the power available from the grid. The power supply across the whole network of charging points can also be controlled according to various other parameters, such as the cost of electricity and commercial arrangements with users.

As technology improves and EVs require faster charging and power modules with higher power ratings are developed, upgrading the system is cheaper and more straightforward, since it is all accessible in a single place, no matter how large the charging station and dispersed the charging points are.

A first aspect of the invention is defined by claim 1.

### BRIEF DESCRIPTION OF DRAWINGS

The invention will now be described, by way of example only, with reference to certain preferred embodiments, which can be better understood by referring to the following drawings.

FIG. 1 depicts a typical EV charging system provided in a car park having sixteen parking bays with respective charging points, using an embodiment of the invention.

FIG. 2 depicts another typical EV charging system comprising a single station unit having a plurality of charging points disposed about a housing which contains the necessary power supply and control circuitry using an embodiment of the invention.

FIG. 3 is a block diagram of a system using an embodiment of the invention.

FIG. 4 depicts an exemplary central charge control system of the invention, including the power modules, and the power switching system which allocates the power from the modules to the charging points.

FIG. 5 depicts the exemplary central charge control system from a side perspective, showing both the positive and negative switches of the power switching system.

FIG. 6 shows the steps in a typical operation of a charging system using the invention.

### DETAILED DESCRIPTION

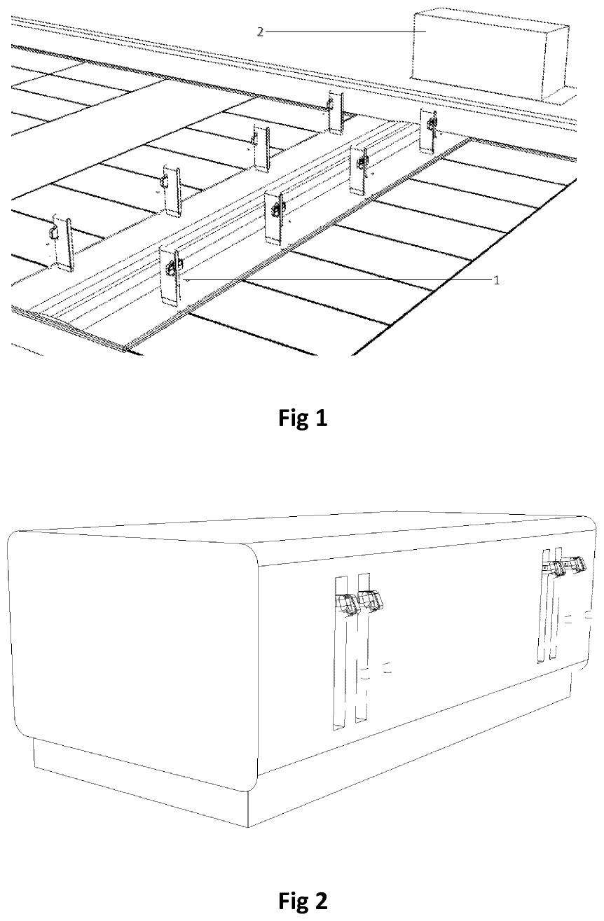

FIG. 1 shows a car park or parking lot providing a number of parking spaces for road vehicles. Some of the parking spaces are provided with EV charging points 2, comprising pillars having charging connectors for connecting to EVs. In the example shown, each pillar supports two charging points 2 and is disposed between two parking spaces, but in other embodiments each pillar could be associated with a different number of charging points. The details of the charging points and their supporting structures are not important to the explanation of the invention; the skilled person will be aware of many suitable charging point configurations which are suitable for the purposes of the invention.

A central charge controller 1 is shown in a housing, separate from the charging points 2. This contains the power switching circuitry and the power modules, as well as the control circuitry used in the invention. The connections between the power modules and switching circuitry, and the charging points, is laid under the car park surface in this embodiment and is not shown.

FIG. 2 shows an alternative EV charging station using the invention. In this case, the housing for the central charging controller 1 also provides the supporting structure for the charging points 2. Such an arrangement is far easier to install, since it does not require any digging to lay power cables. It is also far less spatially distributed than the first embodiment.

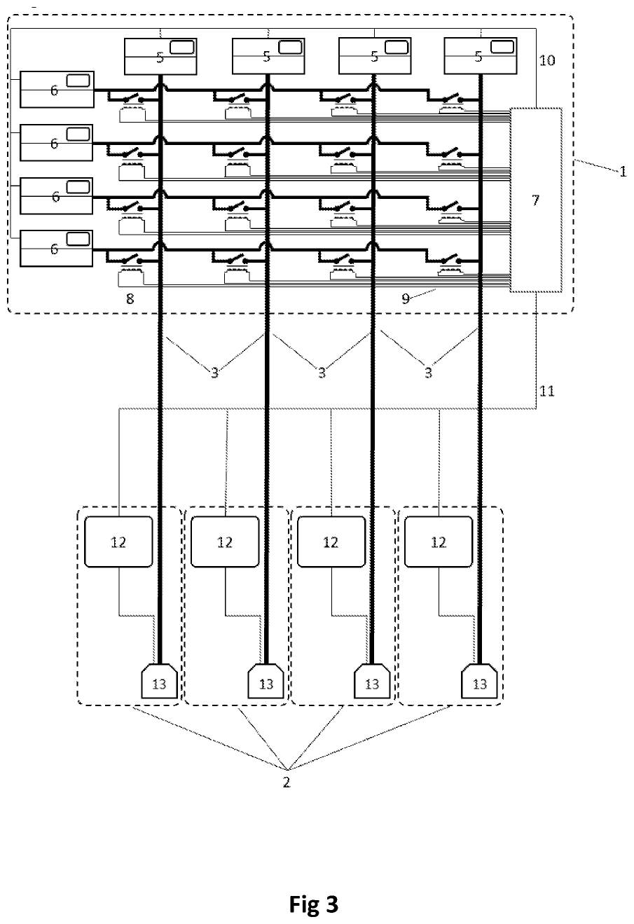

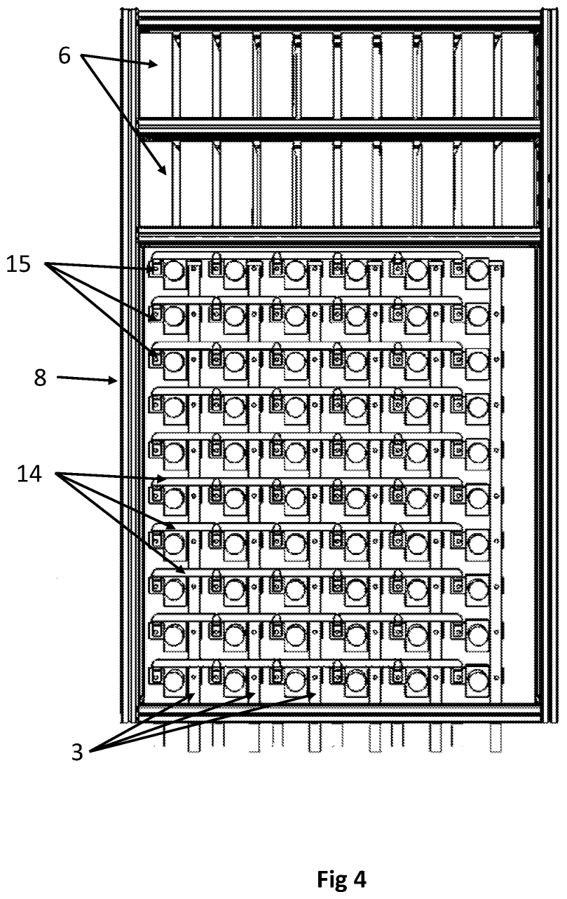

FIG. 3 is a block diagram depicting the components of the invention. The upper section of the diagram shows the components of the central charge controller 1. The lower section shows the charging points 2. A power bus 3 connects the central charge controller 1 and the charging points 2.

A first group of dedicated power modules 5 is contained within the central charge controller 1. These power modules 5 are permanently connected to their respective charge points 2 via the power bus 3.

A second group of free power modules 6 is contained within the central charge controller 1. Each of these can be connected to any one of the charge points 2 via the power switching circuitry 8 and the power bus 3.

The power modules 5, 6 can be any suitable conventional DC power supply circuits. They will typically be powered by a connection to the national grid, although other sources of electrical power can be used as well as or instead of the grid. The inventor has found the 30 kW series EV charging rectifiers provided by UUGreenPower (model number UR100030-E) to be particularly suitable, but any suitable unit can be used.

A system controller 7 is connected to the switches of the switching circuitry 8 via signal lines 9 in order to control their switching. The system controller 7 is also connected to the power modules 5, 6 via a first data network 10, and to the charging points 2 via a second data network 11, in order to receive information about the supply and demand of power.

The signal lines and data networks do not need to be wired. Wireless connection may be useful in some circumstances, via any conventional method. This might be especially useful for the data network 11 between the system controller 7 and the charging points 2, since these may be spaced far apart. It is likely to be preferable to provide a physical link 9 between the switching circuitry 8 and the system controller 7, since these are unlikely to be spaced far apart.

A charge controller 12 is provided to each charging point 2. This communicates when in use with the EV operator, and may have a user interface to receive instructions relating to a charging operation. The charge controller 12 also communicates with the system controller 7 via the data network 11 in order to provide information about power requests to the system controller 7.

A charging cable and connector 13 is also provided at each charging point 2. There are many different types of suitable connectors 13, but typically each of these will, in use, be plugged into a receiving socket on an EV to be charged, forming either a conductive or inductive electrical connection to charge the EV battery.

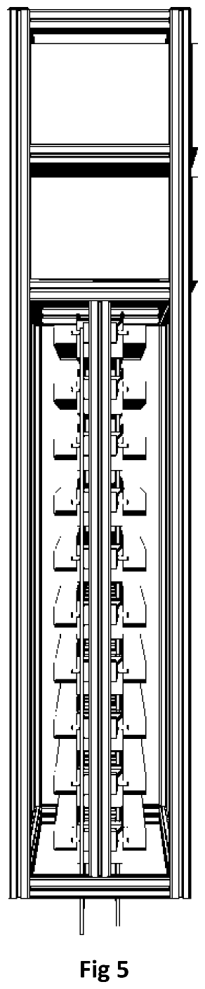

For ease of installation and scaling, the central charge control system is preferably provided in modular cabinets that can be connected together to increase the size of the system. An exemplary layout for such a cabinet is shown in FIGS. 4 and 5. The unallocated power modules 6 are provided in the top two rows.

In this example, each column of two power modules 6 is connected in parallel to function as a single, larger power module. It will be apparent that this principle can be applied throughout the invention. Any of the power modules 5, 6 can in fact comprise a plurality of individual power module units connected together (perhaps switchably) to provide more power.

Each column of power modules 6 is connected to a row of switches on the switching circuit panel 8. Each row of switches comprises a busbar or power cable 14 with a bank of contactor switches 15 that can be switched on or off by the system controller 7 (not shown).

The switching panel 8 is duplicated for positive and negative electrical connections. The negative connections are on the opposite side of the rack, as can be seen in FIG. 5.

The power bus 3 runs vertically from top to bottom, and consists of two separate cables (positive and negative) for each charging point 2.

Thus, as can be seen, the power output from any of the power modules 6 can be connected to any of the power busses 3 feeding the charging points 2. Thus, power can be boosted to any charging point 2 by switching additional power modules 6 onto the appropriate bus 3.

The dedicated power modules 5 are not shown in FIGS. 4 and 5. These are permanently connected to their respective charging points 2, ensuring that a minimum power delivery is always available to all of the charging points 2.

The number of unallocated power modules 6 connected to a particular charging point 2 during an EV charging operation is determined by the system controller 7, and can be dependent on some or all of: the capacity of the vehicle, the overall power available from, e.g. the grid, the commercial agreement between the charging point operator and the EV customer.

The invention means that larger or more modern EVs with larger batteries and greater charging demands can receive as much power as they able to (subject to overall availability), while older or smaller EVs with a smaller capacity can also be charged, at the same time, and at their own maximum power.

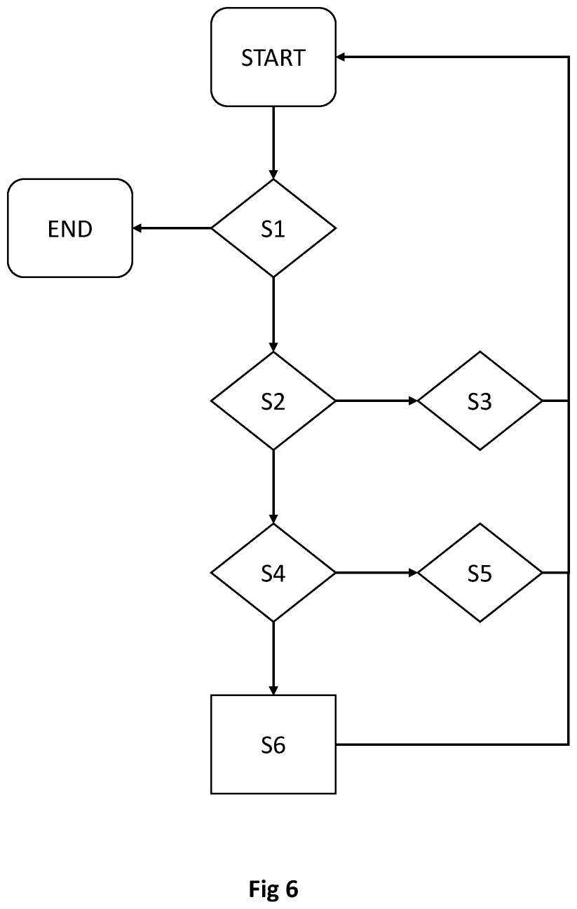

A typical operation for a charging station using the invention is shown in FIG. 6.

A vehicle arrives and connects to a selected charging point 2, communicating a power demand to the system controller 7 via the charging point controller 12. Other information may also be communicated, including identifying information about the user and any commercial priority they may have purchased. At S1, it is determined whether an EV is connected and demand information is being received. If this is not the case, for example if the EV has been disconnected, the process ends and any allocated power modules 6 are disconnected from the selected charging point 2, ready for reallocation.

If it is determined that an EV is connected and communicating a power demand, the process moves to S2, where it is determined whether the power demand exceeds the power provided by the dedicated power module 5 connected to the selected charging point 2. If this is the case, the process moves to S3. Otherwise, the process moves to S4.

At S3, power is supplied to the EV by the dedicated power module. The EV continues to communicate demand to the system controller 7 for as long as it is connected, and the demand level may change, for example as the EV battery approaches a state of full charge. The system controller 7, furthermore, continues to monitor the available power and other relevant factors, for example as power demanded at other charging points 2 changes, the commercial priority of customers connected to the system changes, or power available from the grid and/or other sources varies. Thus S3 loops back to S1.

At S4, it is determined how many allocatable power modules 6 would be required to meet the demand of the EV, and this is used to determine whether there are enough allocatable power modules 6 free to be connected to the selected charging point 2. If this is the case, the process moves to S5. If it is not the case, the process moves to S6.

At S5, the required number of power modules 6 is connected to the selected charging point 2, charging the EV at its requested rate. The EV continues to communicate demand to the system controller 7 for as long as it is connected, and the demand level may change, for example as the EV battery approaches a state of full charge. The system controller 7, furthermore, continues to monitor the available power and other relevant factors, for example as power demanded at other charging points 2 changes, the commercial priority of customers connected to the system changes, or power available from the grid and/or other sources varies. Thus, S5 loops back to S1.

At S6, a number of the available power modules 6 are connected to the selected charging point 2, charging the EV at a reduced rate. The number of modules allocated to the selected charging point 2 may be based on a number of considerations, since the available power modules 6 may need to be shared between several connected EVs with simultaneous demands which exceed availability. The relative size of the demands of the connected vehicles, the order in which they were connected, their current state of charge, and any commercial arrangements with the respective customers may all be considered by the system controller 7 when determining how to allocate the power modules 6 when demand exceeds supply.

The simplest option for managing the allocation of available power modules 6 when there are not enough to meet demand is to use a ‘first come, first served’ system. The vehicle connected to the system for the longest period is allocated all of the available power modules 6 until said vehicle's demand is met. Then the vehicle connected to the system for the second longest period is allocated all of the available power modules 6 until said vehicle's demand is met. This continues in descending order of connection period until all of the power modules 6 are allocated. Any remaining vehicles will still receive power from the dedicated power module 5 to which it is connected, until more power modules 6 become available.

Once the determination has been made and the allocated power modules 6 connected, the EV continues to communicate demand to the system controller 7 for as long as it is connected, and the demand level may change, for example as the EV battery approaches a state of full charge. The system controller 7, furthermore, continues to monitor the available power and other relevant factors, for example as power demanded at other charging points 2 changes, the commercial priority of customers connected to the system changes, or power available from the grid and/or other sources varies. Thus, S6 loops back to S1.

Although the invention has been described by means of a number of preferred embodiments, these embodiments do not limit the scope of the invention. The scope of the invention is determined by the claims.

1. A charging system for charging a plurality of electric vehicles simultaneously comprising: a plurality of charging points; a first plurality of power modules, each one of the first plurality of power modules being connected to a respective one of the plurality of charging points; a second plurality of power modules, each one of the second plurality of power modules being switchably connectable to any one of the plurality of charging points, and a controller configured to control the switchable connections between the second plurality of power modules and the plurality of charging points.

2. A charging system according to claim 1, wherein the controller is configured to receive information about a power demand of an electric vehicle connected to one of the plurality of charging points, and wherein the controller is further configured to control the switchable connections between the second plurality of power modules and the plurality of charging points based on said information received about power demand.

3. A charging system according to claim 2, wherein when it is determined that the power demanded by an electric vehicle connected to one of the plurality of charging points exceeds the power that can be supplied by the one of the first plurality of power modules connected to said one of the plurality of charging points, the controller causes at least one of the second plurality of power modules to be connected to said one of the plurality of charging points.

4. A charging system according to claim 2, wherein when it is determined that a power demand by an electric vehicle connected to one of the plurality of charging points does not exceed the power that can be supplied by the one of the first plurality of power modules connected to said one of the plurality of charging points, the controller causes any power module of the second plurality of power modules that is connected to said one of the plurality of charging points to be disconnected.

5. A charging system according to claim 1, wherein the controller is configured to receive information about a power supply available to the first and second pluralities of power modules from a source of electrical power, and wherein the controller is further configured to control the switchable connections between the second plurality of power modules and the plurality of charging points based on said information received about power availability.

6. A charging system according to claim 1, wherein the controller is configured to receive information about a commercial arrangement made by the user of an electric vehicle connected to one of the plurality of charging points, and wherein the controller is further configured to control the switchable connections between the second plurality of power modules and the plurality of charging points based on said information received about commercial arrangements.
